(19) United States
(12) Patent Application Publication
(10) Pub. No.: US 2011/0035988 A1
(43) Pub. Date: Feb. 17, 2011

(54) ENCLOSURE CHAMBER FOR DETERRING RODENTS

(76) Inventor: Peter L. Mountzoures, Niantic, CT (US)

Correspondence Address: MCCORMICK, PAULDING & HUBER LLP, CITY PLACE II, 185 ASYLUM STREET, HARTFORD, CT, 06103, US

(21) Appl. No.: 12/540,409

(22) Filed: Aug. 13, 2009

(51) Int. Cl. A01M 13/00; A01M 1/24

(52) U.S. Cl. 43/124

(57) ABSTRACT

A rodent barrier in the form of an enclosure housing is provided for an automotive engine compartment, the enclosure housing having an inner compartment for holding a deterrent to discourage nesting by rodents. The enclosure housing includes at least one vent for diffusing a deterrent aroma within said engine compartment. The enclosure housing also includes fastening means for fastening the enclosure housing to a selected placement within the interior of the engine compartment. The fastening means are adapted for removably fastening the housing to the engine compartment.

### TECHNICAL FIELD

The invention relates to rodent deterrents and, more particularly, to rodent deterrents for automotive engine compartments.

### BACKGROUND OF THE INVENTION

The unwanted presence of rats, mice, and other rodents is an ongoing problem in many environments. In particular, rodents oftentimes nest within automotive engine compartments due to the sheltered environment provided by automobiles. However, the nesting rodents may damage the automobile, for example, by chewing through wires or nesting within critical engine components. Additionally, rodents often carry disease and can create unpleasant odors and contamination within the automobile. Various approaches are known in the art for preventing rodent problems. However, these known approaches are not suited for rodent infestations within automobiles.

One conventional means of rodent control is through poisons. The poisons are placed where invading rodents will ingest them and die. However, poisons have a variety of disadvantages. For example, storage and use locations of poisons must be carefully chosen to ensure that the poisons are not accessible to pets or children. Additionally, if poisoned rodents travel away from the poison site before dying, they must be located so that their bodies can be disposed of or the decaying rodent itself can lead to unpleasant odors, contamination and disease.

Another conventional means for rodent control is the rodent trap. Rodent traps are typically strategically placed with bait to capture or kill rodents. Traps tend to be less dangerous than poisons but still must be placed away from children and pets. Additionally, since traps are intended to capture or kill the rodents, a user must dispose of the trapped rodents or risk unpleasant odors, contamination and disease.

Other known means for prevention of rodent infestation include sonic and scent based repellents. Sonic repellents include devices that generate sound waves at frequencies offensive to rats and mice. These devices are typically electrically powered. Some scent-based repellents use predator urine from species including coyote, fox, bobcat, wolf, and mountain lion to deter prey animals from entering a specific area. Users can fill dispensers with predator urine and place them around the perimeter of the specific area.

It is desirable to provide for a new and improved rodent deterrent to discourage rodents from nesting within an automotive engine compartment, which overcomes at least some of the disadvantages of prior art.

### SUMMARY OF THE INVENTION

A rodent barrier in the form of an enclosure housing is provided for an automotive engine compartment, the enclosure housing having an inner compartment for holding a deterrent to prevent nesting by rodents. The enclosure housing includes at least one vent for diffusing a deterrent aroma within said engine compartment. The enclosure housing also includes fastening means for fastening the enclosure housing to a selected placement within the interior of the engine compartment. The fastening means are adapted for removably fastening the housing to the engine compartment. The housing is preferably of metallic construction.

The rodent barrier may selectively and alternatively be mounted within the engine compartment between a level access position, an inwardly and/or downwardly tilted position or an inverted position.

### BRIEF DESCRIPTION OF THE DRAWINGS

The invention will now be described for the purposes of illustration with reference to the following detailed description, taken in conjunction with the accompanying drawings, in which:

FIG. 1 is a perspective view of a rodent barrier according to the present invention in use;

FIG. 2 is a perspective view of the rodent barrier of FIG. 1;

FIG. 3 is a cross-section of the rodent barrier of FIG. 1;

FIG. 4 is a cross-sectional view of another embodiment of the rodent barrier according to the present invention;

FIG. 5 is a cross-sectional view of the rodent barrier of FIG. 4 after being attached within an engine compartment;

FIG. 6 is a cross-sectional view of the rodent barrier of FIG. 1 according to another embodiment of the present invention; and

FIG. 7 is a perspective view of another embodiment of the rodent barrier according to the present invention.

### DETAILED DESCRIPTION OF THE PREFERRED EMBODIMENT

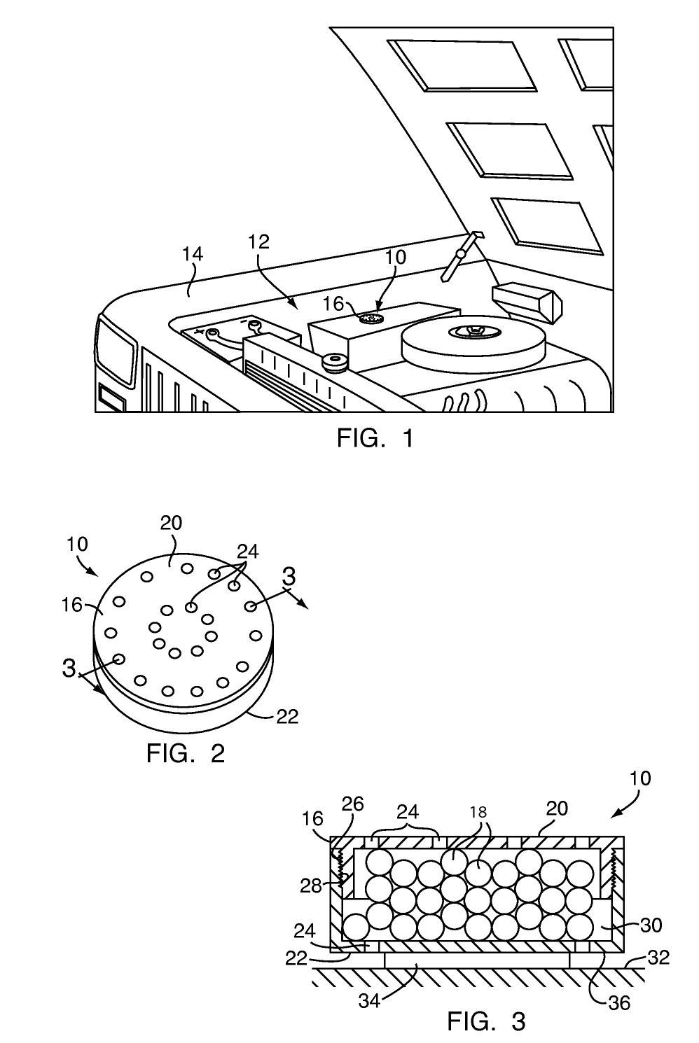

Referring to FIG. 1, a rodent barrier 10 is mounted inside an engine compartment 12 of an automobile 14. Rodent barrier 10 includes a housing 16 containing a deterrent 18, shown in FIG. 3, to prevent nesting by mice and other rodents in the engine compartment 12. A user mounts the rodent barrier 10 within the engine compartment 12 and exposes the deterrent 18 to atmospheric air to deter rodents from nesting within the engine compartment 12.

Referring to FIG. 2, the housing 16 includes a top portion 20 and a bottom portion 22, which are preferably of metallic construction. The top portion includes vents 24 that allow odor from the deterrent 18 to exit the housing 16 and spread into the engine compartment 12. The bottom portion 22 may also include vents 24, as shown in FIG. 3, which also allow odor from the deterrent 18 to exit the housing 16. Preferably, the deterrent 18 disperses an odor into the atmospheric air at room temperature. The phrase “disperses an odor into atmospheric air at room temperature” indicates that the deterrent 18 disperses into the air outside the housing 16 at least at temperatures in the range of about sixty-eight degrees Fahrenheit (68° F.) to about seventy-seven degrees Fahrenheit (77° F.). This does not exclude repellents that disperse into the air at temperatures outside this range such as for use both indoors and outdoors. In fact, depending upon the external environment, it may be preferable to provide a deterrent 18 that disperses into atmospheric air at lower or higher temperatures. Although shown as circular, the vents 24 may be formed in other configurations as long as they are designed to keep the level of deterrent dispersed to atmospheric air below levels objectionable to humans. For example, the vents 24 may instead be rectangular or elliptical slots, a screened portion or any similar venting device known in the art.

Preferably, the deterrent includes naphthalene. Naphthalene is also known as naphthaline, tar camphor, white tar, albocarbon, or antimite and not to be confused with naohtha, is a crystalline, aromatic, white, solid hydrocarbon with formula C₁₀H₈ and the structure of two fused benzene rings. The substance is generally volatile, forming a flammable vapor, and readily sublimes at room temperature, producing a characteristic odor that is detectable at concentrations as low as eight hundredths parts per million (0.08 ppm) by mass. Most naphthalene is derived from coal tar. While the composition of coal tar varies with the coal from which it is produced, typical coal tar is about ten percent (10%) naphthalene by weight. In industrial practice, distillation of coal tar yields an oil containing about fifty percent (50%) naphthalene, along with a variety of other aromatic compounds. This oil undergoes fractional distillation to isolate the naphthalene. Naphthalene's most familiar use is as a household fumigant, such as in mothballs. Naphthalene in mothball form, which is suitable for the present invention is commercially available at various hardware stores and pharmacies, from Willert Home Products, Inc. having its principal place of business at 4044 Park Avenue, St. Louis, Mo., 63110. Other fumigant uses of naphthalene include use in soil as a fumigant pesticide, in attic spaces to repel animals and insects, and in museum storage-drawers and cupboards to protect the contents from attack by insect pests.

Referring to FIG. 3, the top portion 20 includes top threads 26 that engage bottom threads 28 of the bottom portion 22 to form an interior compartment 30 for housing the deterrent 18. Top threads 26 and bottom threads 28 allow the top portion 20 and the bottom portion 22 to be disengaged so that deterrent 18 may be added and/or removed from the interior compartment 30. The vents 24 provide hydraulic communication between the interior compartment 30 and atmospheric air in the engine compartment 12, shown in FIG. 1, thereby exposing the deterrent 18 to the atmospheric air and allowing the deterrent 18 to disperse as discussed above.

The rodent barrier 10 includes fastening means for attaching the rodent barrier 10 to an engine compartment surface 32. For example, the fastening means may include a magnet 34 fixed on a lower surface 36 of the bottom portion 22. The magnet 34 is disposed such that it does not cover the vents 24 in the bottom portion 22 of the housing 16, if present. The magnet 34 removably fastens the rodent barrier 10 to the engine compartment surface 32, which is metal. The engine compartment surface 32 may be any metal surface within the engine compartment 12, for example, an inner fender surface, a firewall surface or any other surface that is responsive to magnetic forces. The force of the magnet 34 should be sufficient to maintain the rodent barrier 10 on the engine compartment surface 32 regardless of whether or not the automobile is operational. Thus, the risk of vehicle damage from a dislodged rodent barrier 10 interfering with vehicle operation is minimized.

Magnet 34 allows the rodent barrier 10 to be detached from the engine compartment surface 32 and subsequently reattached to the engine compartment surface 32 at the same, or, alternatively, a different, location. Magnet 34 is advantageous because it does not experience a degradation in its fastening ability with multiple reattachments, as would be the case with an adhesive fastening means. The removable fastening provided by magnet 34 is also advantageous because it allows the rodent barrier 10 to be removed from the engine compartment 12, providing accessibility to the interior compartment 30 for cleaning of the rodent barrier 10 and/or replenishing deterrent 18. Additionally, the magnet 34 allows the rodent barrier 10 to be relocated within the engine compartment 12 to be closer in proximity to a rodent nest, if discovered, or a location where rodent activity is suspected of occurring.

Although shown as mounted to a horizontal engine compartment surface 32, the magnet 34 may attach the rodent barrier 10 to other surface configurations, including a vertical surface or an angled surface. Additionally, the rodent barrier 10 may be attached to a horizontal surface such that the rodent barrier 10 is fully or partially inverted. Additionally, although described as having a threaded connection between the top portion 20 and the bottom portion 22, the top portion 20 and bottom portion 22 may instead have other known connection means, for example, a snap connection, one or more screw connections or a magnetic connection wherein the top portion 20 is attached to the bottom portion 22 by magnetic forces from magnet 34.

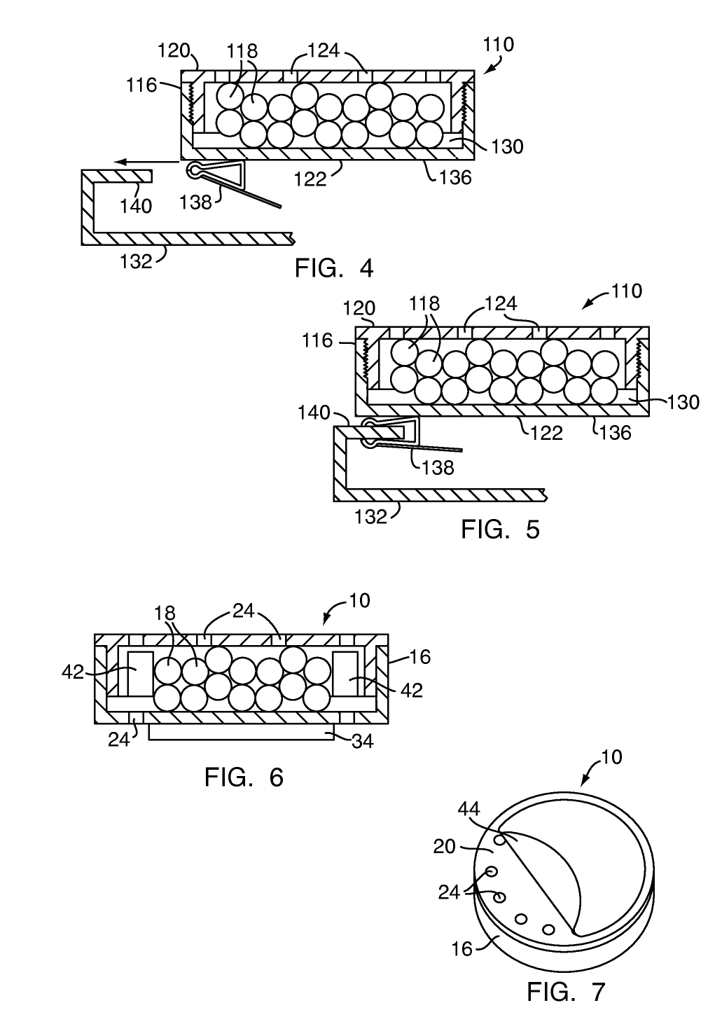

Referring to FIGS. 4 and 5, the fastening means for attaching the rodent barrier 110 to an engine compartment surface 132 may alternatively include a clip 138. The clip 138 is fixed to the lower surface 136 of the rodent barrier 110. The clip 138 removably fastens the rodent barrier 110 to a projection 140 of the engine compartment surface 132. Thus, the clip 138 may fasten the rodent barrier 110 to substantially any static metallic or non-metallic surface within the engine compartment (not show), including, for example, an air filter housing, battery tray or windshield washer fluid tank. The rodent barrier 110 and the clip 138 are formed such that the clip 138 fastens the rodent barrier 110 to the engine compartment surface 132 regardless of whether or not the automobile is operational. Thus, the risk of vehicle damage from a dislodged rodent barrier 110 interfering with vehicle operation is minimized.

Like the magnet 34, the clip 138 allows the rodent barrier 110 to be detached from the engine compartment surface 132 and subsequently reattached to the engine compartment surface 132 at the same, or, alternatively, a different, location. Additionally, the clip 138 allows the rodent barrier 110 to be fastened to additional components within the engine compartment, for example, wires, cables or wire harnesses. The clip 138 is also advantageous because it does not experience a degradation in its fastening ability with multiple reattachments. The removable fastening provided by the clip 138 also allows the rodent barrier 110 to be removed from the engine compartment (not shown), providing accessibility to the interior compartment 130 for cleaning of the rodent barrier 110 and/or replenishing deterrent 118. Additionally, the clip 138 allows the rodent barrier 110 to be relocated within the engine compartment (not shown) to be closer in proximity to a rodent nest, if discovered, or a location where rodent activity is suspected of occurring.

Like the magnet 34, the clip 138 may attach the rodent barrier 110 to a variety of surfaces within the engine compartment, including a horizontal surface, a vertical surface or an angled surface. Additionally, the rodent barrier 110 may be attached to a horizontal surface such that the rodent barrier 110 is fully or partially inverted.

Referring to FIG. 6, the rodent barrier 10 may also include a scented compound 42 to at least partially mask the odor of the deterrent 18, for example, the naphthalene component, from human detection. The scented compound 42 will make the rodent barrier 10 less intrusive to human beings while still providing necessary rodent deterrent capabilities.

The rodent barrier 10 may be contained within a sealed package configured for retail sale so that deterrent 18 is prevented from dispersing into the atmosphere until desired. Additionally, referring to FIG. 7, the rodent barrier 10 may also have a removable cover 44 extending across the vents 24, restricting hydraulic communication between the interior compartment 30 and the atmosphere until the removable cover 44 is removed from the rodent barrier 10. Once removed, hydraulic communication between the interior compartment 30 and the atmosphere is enabled through vents 24.

The rodent barrier 10, 110 is advantageous because it provides a user-friendly way of deterring infestation of rodents, such as mice, rats, and squirrels, within automobiles while avoiding the need to dispose of live or dead rodents associated with traps and poisons.

The rodent barrier 10, 110 is also advantageous because the fastening means provide flexibility with regard to location of the rodent barrier 10, 110 within the engine compartment. Additionally, the fastening means simplify refilling of the rodent barrier 10, 110 with deterrent 18, 118 and cleaning of the rodent barrier 10, 110.

The fastening means also provide flexibility by allowing the rodent barrier 10, 110 to be attached to substantially any engine compartment surface 32, 132. Thus, the rodent barrier 10, 110 may be employed in a wide range of environments and may be conveniently and unobtrusively located. Although described in connection with an automobile, the rodent barrier 10 is also compatible with use on other structures where rodent deterrence is desired, including, for example, manufacturing facilities, food processing plants, other vehicles and dumpsters.

The rodent barrier 10, 110 may also employ other known fastening means, for example, the rodent barrier 10, 110 may include Velcro on lower surface 36, 136 rather than magnet 34 or clip 138. Corresponding Velcro would then be placed in particular locations within the engine compartment 12 to mate with the Velcro of the rodent barrier 10, 110. Care would need to be observed in selecting the locations within the engine compartment 12 for the corresponding Velcro to ensure that heat from the engine does not cause Velcro deterioration.

The rodent barrier 10, 110 will not only deter rodents from entering the engine compartment 12 but also drive them away if they are already present by allowing for a controlled release of the deterrent 18, 118. Since the rodents are not captured or killed, users will not need to dispose of the rodents or their bodies. Additionally, users will not need to handle the deterrent 18, 118, since the rodent barrier 10, 110 may be purchased having deterrent 18, 118 already in the interior compartment 30, 130.

One skilled in the art will understand that various modifications may be made to the embodiments described above without departing from the spirit and scope of the invention. For example, although the rodent barrier 10 is shown as having a circular housing 16, the housing 16 may be formed in other geometric shapes, including, for example, a square, a triangle, an oval, a diamond or a trapezoid.

What is claimed is:

1. A rodent barrier for an automotive engine compartment comprising:
a housing forming a interior compartment, the housing having at least one vent providing hydraulic communication between the interior compartment and an atmosphere;
a deterrent disposed in the interior compartment of the housing and dispersing an odor; and
fastening means disposed on a surface of the housing allowing removable fastening of the rodent barrier to an engine compartment surface.

2. The rodent barrier according to claim 1, wherein the fastening means include a magnet disposed on a lower surface of the housing.

3. The rodent barrier according to claim 1, wherein the fastening means include a clip disposed on a lower surface of the housing.

4. The rodent barrier according to claim 1, wherein the housing includes a top portion and a bottom portion, the top portion threadedly engaging the bottom portion.

5. The rodent barrier according to claim 4, wherein the housing includes a plurality of vents in the top portion of the housing.

6. The rodent barrier according to claim 4, wherein the housing includes a plurality of vents in the bottom portion of the housing.

7. The rodent barrier according to claim 1, additionally comprising a scented compound disposed within the interior compartment to mask the odor of the deterrent.

8. The rodent barrier according to claim 1, additionally comprising a removable cover extending across the at least one vent.

9. The rodent barrier according to claim 1, wherein the deterrent includes naphthalene.

10. The rodent barrier according to claim 9, wherein the deterrent is mothballs.

11. A system for deterring rodent nesting within an automobile comprising:
a housing formed from a top portion and a bottom portion, the top portion and bottom portion threadedly engaging to form an interior compartment;
a deterrent disposed within the housing in the interior compartment, the deterrent dispersing an odor;
a plurality of vents formed in the top portion allowing the odor to exit the interior compartment; and
fastening means disposed on a surface of the housing and attaching the rodent barrier to an engine compartment surface.

12. The system according to claim 11, additionally comprising a plurality of vents formed in the bottom portion allowing the odor to exit the interior compartment.

13. The system according to claim 11, wherein the fastening means include a magnet disposed on a lower surface of the housing.

14. The system according to claim 11, wherein the fastening means include a clip disposed on a lower surface of the housing.

15. The system according to claim 11, additionally comprising a scented compound disposed within the interior compartment to mask the odor of the deterrent.

16. The system according to claim 11, additionally comprising a removable cover extending across the plurality of vents.

17. The system according to claim 11, wherein the deterrent includes naphthalene.

18. The system according to claim 17, wherein the deterrent is mothballs.

19. A device for deterring rodent nesting within an automobile engine compartment, the device comprising:
a housing having an interior compartment formed from a top portion and a bottom portion, the top portion including top threads extending into the bottom portion and threadedly engaging bottom threads of the bottom portion;
a fastening means disposed on a lower surface of the bottom portion of the housing, the fastening means allowing the housing to be detachably connect to any one of a plurality of locations on an engine compartment surface;
a plurality of vents disposed in at least one of the top portion or the bottom portion, the plurality of vents providing hydraulic communication between the interior compartment and an atmosphere around the device; and
a deterrent disposed in the interior compartment and dispersing an odor through at least one of the plurality of vents.

20. The system according to claim 19, wherein the deterrent includes naphthalene.
